(19) United States
(12) Patent Application Publication
(10) Pub. No.: US 2005/0144020 A1
(43) Pub. Date: Jun. 30, 2005

(54) Payment system

(76) Inventors: Saj Muzaffar, Middlesex (GB); Jonathan Peachey, London (GB)

Correspondence Address: LAW OFFICES OF RAYMOND A. NUZZO, LLC, 579 THOMPSON AVENUE, EAST HAVEN, CT, 06512, US

(21) Appl. No.: 10/510,465

(22) PCT Filed: Apr. 30, 2003
(86) PCT No.: PCT/GB03/01859

(30) Foreign Application Priority Data
Apr. 30, 2002 (GB) 0209805.1
May 21, 2002 (GB) 0211593.9

(51) Int. Cl. G06F 17/60

(52) U.S. Cl. 705/1

(57) ABSTRACT

Home purchase of goods or services, including media services delivered via the home user's interactive digital tv or DAB radio (for example the availability of a pay film or participation in a game or competition) may involve use of the purchaser's credit card or the use of a telephone modem installed in the users tv or tv set top box and connected via land line to the public service telephone network, the modem then initiating a call to a premium rate telephone number in order to pay for items purchased. Some people do not have credit cards or may dislike using them for home purchase because of certain security related factors. Meanwhile, not all tv's and set top boxes have telephone modems installed or, if they are installed, they may not be connected. At present, it is rare for modems to be installed in DAB radios. In the payment system disclosed herein a digital broadcast transmitter (6) and local receiver (1,2,3 and 5) make available to the customer a coded text message denoting said goods or services and identifying the said receiver. A mobile telephone (4) is then used to send the coded message to a text message receiving center (7) where it is automatically decoded. The message may be sent via an Internet web site using a WAP telephone. The cost of the goods or services is then debited to the mobile telephone account. For preference, the combined cost of the goods or services and the cost of sending the text message to the message center are debited to the mobile telephone account through use of a premium rate text message destination. The system is particularly suitable for delivering a service through the receiver, for example delivering participation in a game or competition.

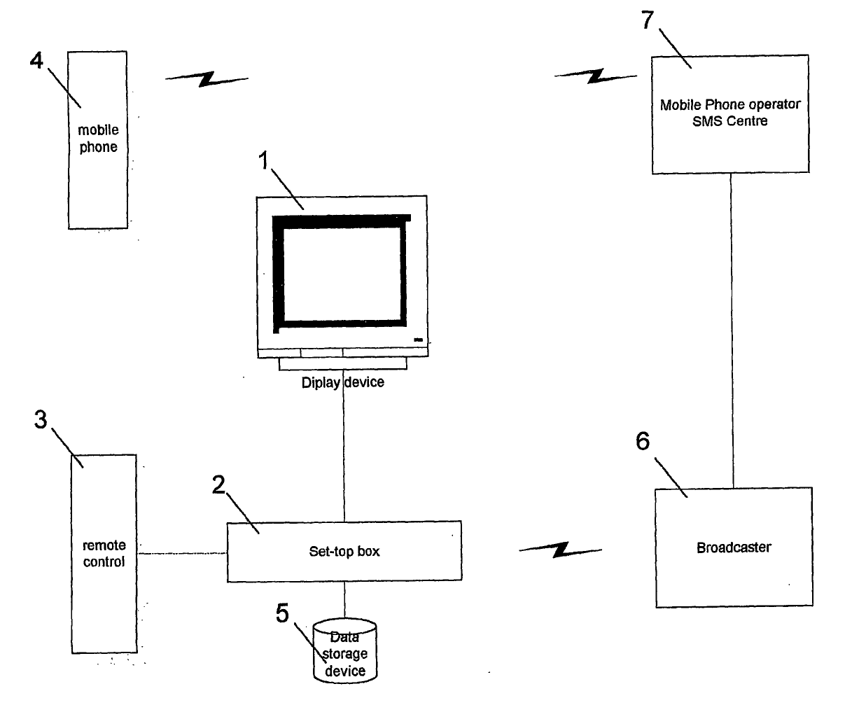

The present invention relates to apparatus and method for an interactive TV and radio payment system used for the purchase of goods, services or entry into a game or competition.

Generally, Interactive TV billing is carried out by the use of a credit/debit card or by adding the charges to the user's subscription fee or via the use of premium rate telephony. Interactive radio through DAB (Digital Audio Broadcasting) and through distribution through interactive TV platforms will also want to make use of payments systems.

These conventional billing systems have restrictions and limitations; for example, gaming and betting laws do not allow payment for entry into some competitions using any form of credit. Competition entry fees may be sufficiently low that credit/debit card payments are uneconomical due to administration costs. A reasonably large percentage of the population does not have the use of a debit card, credit card or, a charge card; therefore service providers and competition operators are losing potential sales every day.

Many people today are still reluctant in making online payments with their credit, charge or debit cards due to the fear of fraud.

Premium rate telephone billing systems require that the equipment be permanently connected to a telephone network e.g. PSTN. Cable TV set-top boxes are not equipped with a standard telephone modem and the cost of adding a telephone modem in these devices can be costly in both hardware and installation, and in some cases not possible, as cable TV set-top boxes are usually not manufactured or designed to accommodate a telephone modem.

In addition the billing arrangement for premium rate telephone billing, is such that all the transactions are billed to the one telephone bill, making it difficult to control and/or monitor usage, especially in the case where several people in the same household are using the premium rate telephone billing services, the telephone's bill payer is usually burdened by everyone else's usage.

Also, in systems that connect to a broadcaster via a modem and the public telephone system, it is not possible to guarantee that all set top boxes are connected in this way, In fact, for self-installation interactive TV systems it is likely that the majority of set top boxes may not be connected to the telephone system.

Finally, most DAB receivers have no facility for making a return connection to a broadcaster and service provider and do not have mechanisms that allow listeners to pay for goods and services.

The object of this invention is to allow the purchase of goods, services or entry into games or competitions, without any of the above disadvantages.

The present invention relates to the method and apparatus for an Interactive TV and interactive radio payment system which uses premium rate messaging. In this specification the term premium rate message payment refers to a system that automatically generates a code derived from the service requested and a unique user apparatus identification number, which the user sends via a Wireless device e.g. mobile phone, by messaging, to a designated number, this may be a telephone number or other number e.g. IP address or the like, the said code, in order to receive the goods or services, wherein part of the cost of sending the said code by message, is for the goods or services.

Once the message is received by the wireless device's messaging center, the message (or notification of receipt and the contents thereof) is then transmitted to the broadcaster/service provider who then interprets it, identifying which user's apparatus is requesting the service and which service is being requested. Receipt of the message is confirmation to the broadcaster/service provider that a charge has been billed to the user's wireless device. Thus, the broadcaster/service provider can then instruct its broadcasting/transmitting equipment to provide access to the desired service either by transmitting it, this may be by means of a wired e.g. cable or wireless transmission e.g. satellite, or allowing the set top box to retrieve it using a wired or wireless connection.

The user pays via their wireless device. This may appear as items on their bill for subscribers on a monthly payment contract or simply deducted from their phone credit for pay as you go users. The act of sending the message, or of receiving one in response, triggers the payment.

The wireless device messaging center may be connected to the broadcaster by means of the Internet or it may be by means of a dedicated connection e.g. leased line for the purposes of security. The data sent may be compressed, encrypted or otherwise manipulated in order for a secure and fast delivery from the mobile operator to the broadcaster. It may be by a wireless, radio, fibre optic, microwave or satellite transmission.

The said code may be generated by means of a software algorithm that is either transmitted with the interactive service, it may be stored integral to the apparatus or it may be stored on a user's subscriber smart card. It may be changed locally or remotely. The purpose of the algorithm is to create a code, which is generated from the apparatus identification number and the service requested. Every service may have a service number assigned to it, which is transmitted to the user's apparatus.

When the user sends this code, as a message via a wireless device, the broadcaster knows which user's apparatus is requesting the service and which service. In addition the code may also include the cost of the service or the cost of the service may be determined by the destination address the code is sent to by the wireless device, for example in a GSM mobile telephone system all £1 charge messages are sent to short code 4545 and all £2 sent to 2212, etc.

The telephone number that the code is sent to may be a fewer digit telephone number, making it quick to input into a wireless device.

The said code may be sent as a text message (alpha-numeric), SMS (Short message system), MMS (multi-media message system), EMS (enhanced message system) it may sent by means of WAP (wireless Application protocol), wherein the user logs onto a WAP server, and inputs the said code, in this case the cost of connecting to the WAP server, via a premium rate connection, is the cost or part of the cost for the service requested. The wireless device communications may be by means of a GSM, GPRS, IMode, UTMS, 3G, 3.5G or 4G wireless network or a combination thereof.

In this specification the term Interactive TV refers to a television receiving apparatus that has the means to receive broadcast programmes and the means operable by a viewer to interact with the said broadcast programmes. The term is also intended to cover radio services received either through television viewing apparatus or through DAB equipment.

The user apparatus unique identification number (AUID) may be electronically stored in the electronics of the apparatus, for example on a ROM (read only memory), it may be removable, for example a smart card. It may be a MAC address (media access control) or a NIC Address (Network Interface card), or combination thereof. It may have been created during manufacture and therefore not changeable.

For the purposes of this specification the word “interact” includes, but is not limited to mean participate, play, (game/competition), request (services/goods), select, choose or the like.

In this specification the term online refers to any means of communication for receiving and/or displaying information and/or services stored remotely and accessible to a user by means of a wired or wireless communication. This may be a cable, telephone (including ISDN and ADSL), satellite, or terrestrial communications network.

The apparatus may be connected to or be integral to a set-top box, computer, television or any other device that has the ability to offer online goods, services. A set-top box is a dedicated computer system for receiving broadcast programmes, it generally has the same core components as a personal computer e.g. microprocessor, RAM, Operating system, ROM, I/O.

Every set-top box has a unique MAC/NIC address, this address is a unique identification number, that enables the set-top box to be identified from all the other set-top boxes, generally it is a permanent address assigned during manufacture, however it may be on a micro-chip e.g. smart card, that is inserted in the set-top box, in order to give it its own unique address/number. A combination of an embedded and user-insertable device may be required to generate the unique address.

The apparatus may have the means to encrypt and decrypt all data sent and received to and from the apparatus.

A preferred embodiment of the present invention will now be described by way of example only with reference to the accompanying illustration, which is a block diagram of the components and operable parts necessary to this particular embodiment of the present invention.

The apparatus of the example depicted comprises a set-top box 2, which receives all broadcast programmes, interactive applications, and data from the broadcaster/service provider, data storage device 5. ROM, (read only memory), Smart card or the like, which stores a unique user apparatus identification number, enabling the broadcaster to identify the set-top box from all other set-top boxes, a display device 1, in this case, a television, monitor or other display device, for the display of all video, graphics and information from the set-top box 2. a mobile phone 4, for the user to send SMS messages, Broadcaster 6 to transmit all programmes and data to the set-top box.

A mobile operator messaging center 7. In this example the messaging center receives the SMS messages from the user's mobile phone 4.

In one embodiment of the invention the input device 3 is a remote control unit allowing the user to interact with the set-top box by selecting the appropriate buttons.

The set-top box 2 receives broadcast programmes by means of a cable, terrestrial, satellite, or other wired or wireless network from the broadcaster 6.

When an interactive service is required, the customer selects from the display device 1 the service required; in this example entry to play a game, by means of the input device 3. This action causes a signal to be sent to the set-top box 2. The software on the set-top box 2 then receives the apparatus unique identification address from data storage device 5 and a code from the said received game application from the memory in the set-top box 2 the algorithm stored on the data storage device 5 then processes the AUID and the game application requested number and produces a code. In addition the set-top box 2 retrieves from the game software the cost for playing the game and assigns a telephone number for that value, that the user must send the premium rate SMS message to.

The user is then presented a screen displaying the said code and said service telephone number, and is instructed to send the said code to the said telephone number by SMS using his mobile phone 4.

The mobile phone operator-messaging center 7 applies the relevant charge to the customers account or to the credit on their phone the moment the SMS message is received. Part of the cost for sending this message is for the entry fee into the said game, in course of, or as a direct or indirect consequence of delivery of the message.

The mobile phone message center 7 then notifies the broadcaster 6 that a payment message has been received and provides all relevant information including the user's telephone number and the code entered. The broadcaster then deciphers which set-top box 2 and which game the user has requested and automatically transmits a signal to the users to set-top box 2, to either receive the said game or allow the user to play the said game on display device 1.

In another embodiment of the present invention the mobile phone message center 7 may send a message back to the user, confirming his request and for the cost of the service. In this case the charge for the service may be by means of a reverse premium rate SMS message, instead of being charged when the outbound SMS message is received by the mobile phone messaging center.

The customer's details (name, address, etc.) may be transmitted to the broadcaster or other remote online computer or other online device to register the transaction for audit and statistical purposes.

The apparatus may have the means to restrict access to certain restricted services (e.g. adult content) by means of a password or other access control system or the combination thereof. In the case of a restricted services (adult content, gambling) the user in addition to sending the code may also have to send a PIN or password to the message center or the like. The user may be assigned a PIN or password by registering for said restricted services, this may be-by post, Internet or other wired or wireless registration.

In another embodiment of the present invention the data storage device may be a smart card that the user is provided when the set-top box is installed/delivered.

In another example of the present invention user interaction may be employed in addition to or instead of the remotecontrgl unit such as a mouse, keyboard rollerball, joystick or the like.

In another example of the present invention the set-top box may be a personal computer equipped to receive broadcast services from the broadcaster.

In another embodiment of the present invention the set-top box may be directly connected to the mobile operators message center, this may be by means of wired or wireless connection to a mobile phone or the like. In the case of a wireless connection, it may be by means of infra-red, bluetooth or other local wireless communications, which may connect and transmit a message from the set-top box to a user's mobile phone. In one example of a wired connection, the set-top box may have a mobile phone or the like integral to it.

Therefore it is to be understood that the present invention can be embodied in a variety of ways other than specifically stated or depicted herein, without departing from the scope of the present invention.

1. a payment system for use in conjunction with the supply of goods and services, the system comprising:
i) supplier apparatus including a transmitter for broadcasting digital signals and a mobile telephone text message receiving center coupled to the transmitter; and
ii) customer apparatus including a digital signal receiver for receiving said broadcast digital signals from said transmitter and a mobile telephone for sending text messages to said text message receiving center;
iii) said transmitter and said receiver being operable for making available through said receiver a coded message denoting goods or services to be supplied and identifying said receiver, and said mobile telephone text message receiving center being operable for responding automatically to the receipt of said coded text message; for decoding the message, and for initiating the supply of said goods or services and for debiting the cost of the goods or services to the mobile telephone account:

2. An interactive digital signal broadcasting system for enabling the supply of goods or services and exacting payment therefor, the system comprising:
i) a transmitter for broadcasting digital signals and being operable for causing a broadcast digital signal receiver to make available at the receiver a coded text message denoting goods or services to be supplied to the customer and identifying said receiver; and
ii) a mobile telephone text message receiving center coupled to the transmitter; the message receiving center being operable for responding automatically to the receipt of said coded text message sent by a customer via a mobile telephone for initiating supply of said goods or services and for debiting the cost thereof to the mobile telephone account.

3. A system for enabling the supply of goods or services and exacting payment therefor, the system comprising a mobile telephone text message receiving station including receiving and decoding means for receiving and automatically decoding text messages sent to the station by mobile telephone users, said system being operable for receiving a coded text message forwarded via a mobile telephone after that coded message has been made available to the mobile telephone user by a broadcast digital signal receiver and broadcast digital signal transmitter, said coded message denoting goods or services to be supplied and identifying said receiver, and automatically decoding said message and enabling supply of said goods and services and debiting the cost thereof to the mobile telephone account.

4. A system for enabling the supply of goods or services and exacting payment therefor, the system comprising a digital broadcast transmitting station operable for broadcasting information denoting goods or services to be supplied and operable for causing a broadcast digital signal receiver to make available to a user a coded text message denoting said goods and services and identifying said receiver, and further for inviting said user to send said coded text message to a text message receiving center that includes receiving and decoding means for receiving and automatically decoding the message, and automatically enabling supply of said goods or services and debiting the cost thereof to the mobile telephone account.

5. In a method in which goods or services are offered to a customer through a digital signal broadcast transmitting station and a digital signal receiver, a system for exacting the cost of goods or services to be taken by the customer, the system comprising the following steps:
i) causing the transmitter and receiver to make available to the customer a coded text message denoting said goods or services and identifying the said receiver;
ii) at a text message receiving center operable for receiving text messages sent to it by mobile telephone, automatically decoding said coded text message to identify said goods or services and said receiver; and
iii) debiting the cost of said goods or services to the mobile telephone account.

6. A system according to claim 5, including between steps (ii) and (iii): automatically sending a confirmation message back to the mobile telephone, step (iii) being carried out as an automatic cosequence of sending the confirmation message.

7. A system for enabling the supply of goods or services and exacting payment therefor, the system including the step of using a mobile telephone text message receiving station that comprises receiving and decoding means for receiving and automatically decoding text messages sent to the station by mobile telephone users, receiving a coded text message forwarded via a mobile telephone after that coded message has been made available to the mobile telephone user by a broadcast digital signal receiver and broadcast digital signal transmitter, said coded message denoting goods or services to be supplied and identifying said receiver, and automatically decoding said message and enabling supply of said goods and services and debiting the cost thereof to the mobile telephone account.

8. A system for enabling the supply of goods or services and exacting payment therefor, the system including the step of using a digital broadcast transmitting station, broadcasting information that denotes goods or services to be supplied and that causes a digital signal receiver to make available to a user a coded text message, which message denotes said goods and services and identifies said receiver, and invites said user to send said coded text message by mobile telephone to a text message receiving center operable for automatically decoding the message, automatically enabling supply of said goods or services and debiting the cost thereof to the mobile telephone account.

9. A system according to claim 8, operable to deliver a service through said broadcast digital signal receiver, for example to deliver participation in a game or competition played on said receiver.

10. A system according to claim 8, operable for said coded text message to be sent by mobile telephone to an Internet web site coupled to said message center.

11. A system according to claim 8, wherein the combined cost of the goods or services and the cost of sending the text message to the message center are debited to the mobile telephone account through use of a premium rate text message destination.

12. A system according to claim 8, operable for said cost to be debited to an account for subsequent payment by the mobile telephone account holder or to be debited to a pre-paid credit assigned to a pay-as-you-go (pre-payment) mobile telephone user.
